(19) United States
(12) Patent Application Publication
(10) Pub. No.: US 2005/0149637 A1
(43) Pub. Date: Jul. 7, 2005

(54) Methods of restoring operation of serial ATA storage devices

(76) Inventors: Douglas John Fox, Livermore, CA (US); Wayne Eugene Miller, Livermore, CA (US); Paul Thomas Petersen, Milpitas, CA (US)

Correspondence Address: Robert Moll, 1173 St. Charles Court, Los Altos, CA, 94024, US

(21) Appl. No.: 11/072,145

(22) Filed: Mar. 3, 2005

Related U.S. Application Data
(62) Division of application No. 10/677,560, filed on Oct. 1, 2003.
(63) Continuation-in-part of application No. 10/264,603, filed on Oct. 3, 2002.

(51) Int. Cl. G06F 13/10

(52) U.S. Cl. 710/5

(57) ABSTRACT

The present invention relates to systems and methods for providing multiple access paths to a single ported storage device used in data storage subsystems. In an embodiment, the system provides circuitry associated with single ported storage devices, including a coupling circuit with a microcontroller for signals which include the data and control paths to and from redundant storage device controllers. In this embodiment, the additional control in the form of discrete signal lines or through additional commands is used to manage routing of the signals to and from a redundant data storage controller. Further, each redundant data storage controller preferably has its own primary set of storage devices. If one of the controllers fails, the redundant controller can switch its control to the failed controller's storage devices thus maintaining user access to the data contained on those storage devices.

### BACKGROUND

This application is a continuation-in-part of U.S. application Ser. No. 10/264,603, Systems and Methods of Multiple Access Paths to Single Ported Storage Devices, filed on Oct. 3, 2002 (Attorney Docket No. Pillar 701), which is incorporated herein by reference.

This application also incorporates herein by reference as follows:
U.S. application Ser. No. 10/354,797, Methods and Systems of Host Caching, filed on Jan. 29, 2003 (Attorney Docket No. Pillar 709);
U.S. application Ser. No. 10/397,610, Methods and Systems for Management of System Metadata, filed on Mar. 26, 2003 (Attorney Docket No. Pillar 707);
U.S. application Ser. No. 10/440,347, Methods and Systems of Cache Memory Management and Snapshot Operations, filed on May 16, 2003 (Attorney Docket No. Pillar 713);
U.S. Application No. Unknown, Systems and Methods of Data Migration in Snapshot Operations, filed on Jun. 19, 2003 (Attorney Docket No. Pillar 711), Express Mail Label No. EJ039579912US; and
U.S. application Ser. No. 10/616,128, Snapshots of File Systems in Data Storage Systems, filed on Jul. 8, 2003 (Attorney Docket No. Pillar 714).

The Internet, e-commerce, and relational databases have all contributed to the tremendous growth of data storage, and created an expectation that the data must be readily available all of the time. The desire to manage this data growth and produce high availability to the data has encouraged development of storage area networks (SANS) and network-attached storage (NAS). SANs move networked storage behind the server, and typically have their own topology and do not rely on LAN protocols such as Ethernet. NAS frees storage from its direct attachment to a server. The NAS storage array becomes a network addressable device using standard Network file systems, TCP/IP, and Ethernet protocols. However, both SANs and NAS employ at least one server connected to storage subsystems containing the storage devices. Each storage subsystem will contain multiple storage nodes, each node including a storage controller and an array of enterprise class storage devices, usually magnetic disk (hard disk) or magnetic tape drives.

Fibre channel (FC) and Serial Storage Architecture (SSA) technology achieve high availability of data by using expensive dual ported disk drives. The dual ported drives provide a primary I/O path and a redundant I/O path if the primary I/O path to the data fails. SCSI architecture achieves high availability of data by linking hosts on the SCSI I/O bus along with a set of single ported storage devices. Although it is possible to connect, for example, two hosts and fourteen disks on the SCSI bus, the result is difficult to maintain and troubleshoot if it fails. In either type of technology, if a failure occurs on one storage controller, the redundant storage controller or the additional dedicated storage controller is used to access the data storage devices.

The additional cost of these architectures and enterprise class disk drives is paid for by users who justify the cost as necessary to maintain the desired multiple access paths for data critical applications.

PC disk drives are manufactured in high volumes with an eye to increasing storage capacity and minimizing cost rather than provide high availability of data. In fact, the cost of PC disk drive controllers is so inexpensive many PC motherboards sold today have an ATA host controller chip. On the other hand, PCs do not have redundant ATA controllers or dual ported disk drives because the need for high availability of data is not as significant a concern. Further, the commodity status of PC single ported disk drives does not encourage changing the single port to dual porting, which would raise the overall cost of the PC disk drive.

It would be useful to leverage the low cost and the technology advancements of PC data storage devices in network storage systems. It would be desirable to ride down the price-performance curve with PC disk drives while adding low cost means for providing multiple access paths to the data on the drives.

### SUMMARY OF THE INVENTION

The invention relates to data storage subsystems including a plurality of storage nodes and storage devices. In an embodiment, the invention provides multiple access paths and power control to at least one single ported storage device. In this embodiment, the invention provides circuitry, including a coupling circuit for communication paths to and from at least one redundant storage controller. Further, each storage controller may have its own primary set of storage devices. If that controller fails, a redundant controller can access data on the failed controller's storage devices.

It is an objective of the invention to provide high availability to data on a storage device that has only a single access path to the data by permitting multiple access paths to the storage device.

It is another objective of the invention to provide multiple access paths without altering the electronics of high volume production, single access path, hard disk drives.

It is still another objective of the invention to provide a lower cost solution for storage devices than is currently being used in FC and SSA dual ported drives or SCSI dual host environments.

### BRIEF DESCRIPTION OF THE DRAWINGS

FIG. 1 illustrates an embodiment of the data storage subsystem with two storage nodes sharing a common midplane.

FIG. 2 is an embodiment of an algorithm for monitoring the operation of the first storage node and invoking path control.

FIG. 3 illustrates the control of the coupling circuits and the communication paths where all storage nodes are operating properly.

FIG. 4 illustrates the control of the coupling circuits and the communication paths where the second storage node has failed, and the first storage node takes over the control of the storage devices k and 2k-1.

FIG. 5 illustrates the control of the coupling circuits and the communication paths where the second storage node has failed, and the first storage node resumes control of the storage devices 1 and k-1.

FIG. 6 illustrates the control of the coupling circuits and the communication paths where the first storage node has failed, and the second storage node takes over the control of the storage devices 1 and k-1.

FIG. 7 illustrates the control of the coupling circuits and the communication paths where the first storage node has failed, and the second storage node resumes control of the storage devices k and 2k-1.

FIG. 8 is a block diagram showing details of the coupling circuit.

FIG. 9 is a logic diagram showing the path control.

FIG. 10 illustrates an embodiment of a data storage subsystem using serial communication paths between the storage controllers and the sets of storage devices.

FIG. 11 illustrates the details of a coupling circuit and a command table.

FIG. 12 illustrates the data storage subsystem using serial communication paths between the storage controllers and the storage devices during normal operation.

FIG. 13 illustrates the data storage subsystem using serial communication paths between the storage controllers and the storage devices when the second storage node has failed.

FIG. 14 illustrates the data storage subsystem using serial communication paths between the storage controllers and the storage devices when the first storage node has failed.

FIG. 15 illustrates the assigning of storage devices to storage controllers.

### DETAILED DESCRIPTION OF THE PREFERRED EMBODIMENTS

The following description includes the best mode of carrying out the invention. The detailed description is made for the purpose of illustrating the general principles of the invention and should not be taken in a limiting sense. The scope of the invention is best determined by reference to the claims. In the Figures, the same part is assigned the same part number.

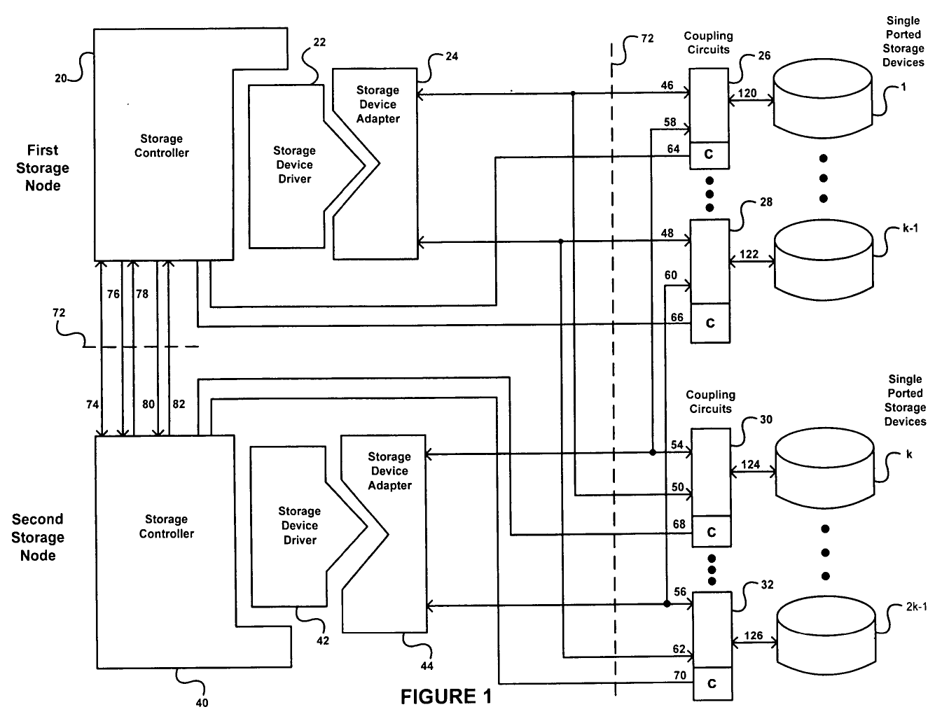

FIG. 1 depicts an embodiment of a data storage subsystem with a first storage node and a second storage node sharing a common midplane, where each storage node is illustrated as having access to a plurality of storage devices. The application will determine the appropriate number of storage nodes and storage devices to be used. For example, an enterprise application typically includes additional storage nodes and storage devices. The solid dots in FIG. 1 represent the additional coupling circuits and storage devices one might add in an enterprise application.

As shown in FIG. 1, the first storage node includes a storage controller 20, a storage device driver 22, a storage device adapter 24, and coupling circuits 26 and 28, and its primary storage devices 1 and k-1. The communication path 46, the coupling circuit 26, and the communication path 120 provide a path from the storage device adapter 24 to the primary storage device 1. The communication path 48, the coupling circuit 28, and communication path 122 provide a path from the storage device adapter 24 to the primary storage device k-1. The communication path 50, the coupling circuit 30, and the communication path 124 provide a path from the storage device adapter 24 to its secondary storage device k. The communication path 62, the coupling circuit 32, and the communication path 126 provide a path from the storage device adapter 24 to its secondary storage device 2k-1. Tanenbaum, Modem Operating Systems (2nd Edition 2001) and Patterson & Hennessey, Computer Architecture: A Quantitative Approach (3rd Edition 2002) describe data storage systems, input/output, storage devices, device drivers, controllers, and the software, and are both hereby incorporated by reference.

The second storage node includes a storage controller 40, a storage device driver 42, a storage device adapter 44, coupling circuits 30 and 32, and its primary storage devices k and 2k-1. The communication path 54, the coupling circuit 30, and the communication path 124 provide a path from the storage device adapter 44 to the primary storage device k. The communication path 56, the coupling circuit 32, and the communication path 126 provide a path from the storage device adapter 44 to the primary storage device 2k-1. The communication path 58, the coupling circuit 26, and the communication path 120 provide a path from the storage device adapter 44 to its secondary storage device 1. The communication path 60, the coupling circuit 28, and the communication path 122 provide a path from the storage device adapter 44 to its secondary storage device k-1. The states of the path control lines 64, 66, 68, and 70 will determine which communication path(s) are used in a given operation as described below.

In an embodiment, the storage controllers 20 and 40 are implemented in hardware that accepts commands for data from a host (not shown) and routes the commands to the appropriate storage device adapters 24 and 44. As is known, the hardware may be mounted and connected on a printed circuit board. The storage controllers 20 and 40 include a front-end interface that may be SCSI, Fibre Channel, Infiniband, Ethernet or some other interface capable of bidirectional data transfer. The back-end interface may be SCSI, Serial ATA, Fibre Channel or any other data storage interconnect capable of bidirectional data transfer. In an embodiment, the back-end interface is based on the Serial ATA specification, Version 1.0, which is hereby incorporated by reference. The hardware between the front-end interface and the back-end interface comprises, for example, Intel based processor(s), associated program and data memory (e.g., ROM and/or RAM), and an internal I/O path, which couples the front-end interface with the back-end interface. In an enterprise application, the subsystem preferably employs redundant power supplies and fans.

In an embodiment, the storage device drivers 22 and 42, implemented in software or firmware, coordinate operation of the storage controllers 20 and 40. Each storage device driver can be a program written in a high level language such as C or C++, stored in nonvolatile memory, for example, flash memory, and run in each storage controller's processor. The program controls the bidirectional data transfer to and from the storage controllers and the storage devices. The storage device drivers 22 and 42 can select the storage devices 1, k-1, k, and 2k-1 by invoking control signals as described below.

In an embodiment, the storage device adapters 24 and 44 are hardware that bridges the internal I/O path to the external storage device interface. For example, the storage device adapters 24 and 44 could bridge PCI-X to Serial ATA. In an embodiment, the coupling circuits 26, 28, 30, and 32 are embodied in hardware, described in detail below, to allow communication paths to the storage devices 1, k-1, k, and 2k-1.

In an embodiment, the storage devices 1, k-1, k, and 2k-1 are single ported Serial ATA hard disk drives. The Serial ATA Working Group, www.serialata.org for details, has developed and proposed Serial ATA replace parallel ATA technology. Serial ATA would be compatible with existing ATA device drivers, be able to communicate at higher transmission speeds over longer distances, and be compatible with networking, which is a serial transport.

Alternatively, the storage device could be any single ported I/O device that store information in addressable blocks. For example, the storage device could be a magnetic disk drive, a tape drive, a CD-RW media, DVD or any other block storage device. Serial communication has advantages, but the single ported storage devices could be parallel devices.

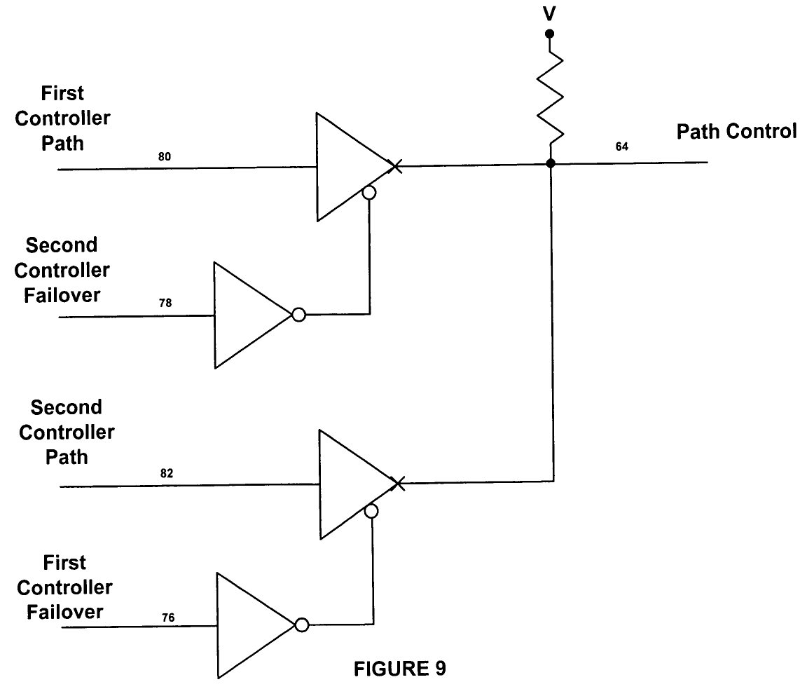

In an embodiment shown in FIG. 1, the data storage subsystem includes a common midplane 72 providing physical and/or electrical interconnections between the first storage node and the second storage node. Preferably, the common midplane 72 does not include any electrically active components, reducing the probability of failure. The common midplane 72 provides separate communication paths between storage controllers 20 and 40 freeing up available bandwidth for data transfer between the first and second storage controllers 20 and 40 and the single ported storage devices 1, k, k-1, and 2k-1. In other embodiments, the data storage subsystem provides cabling and/or wireless transmission media to functionally replace the common midplane 72. In these embodiments, the plurality of storage nodes could be housed in the same or in separate enclosures. In either embodiment, the first and second storage nodes monitor each other's operations by communicating on the heartbeat path 74. The first and the second controller failovers 76, 78, and first and second controller paths 80, 82 are used for communication path control as discussed below (FIG. 9).

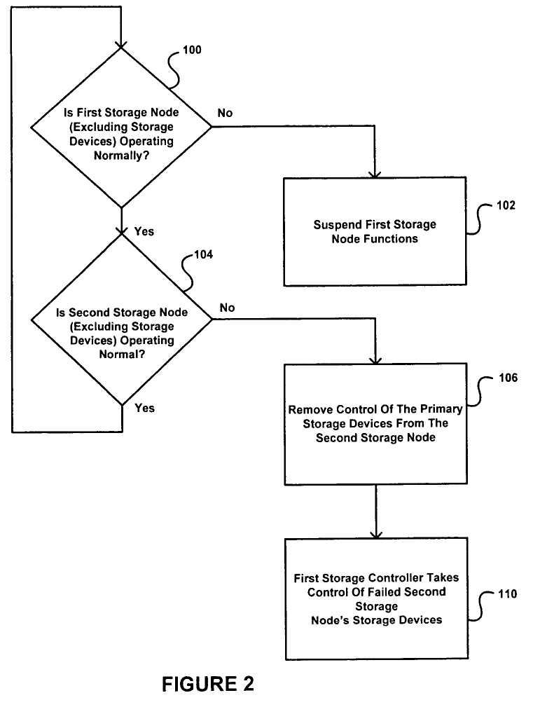

As shown in FIGS. 1-2, an algorithm runs in processor(s) of each storage controller as a monitoring and path control system. For example, at step 100, the algorithm determines if the first storage node, excluding the storage devices, operates normally, that is, reads and writes reliably to its storage devices. If not, the algorithm proceeds to step 102, where the algorithm suspends operation of the first storage node excluding the storage devices. The heartbeat pattern is interrupted on the heartbeat path 74, which is detected by the second storage controller 40. On the other hand, if the first storage node operates normally, the algorithm proceeds to step 104. At step 104, the first storage controller 20 monitors the heartbeat path 74 and determines if the second storage node operates normally. If so, the algorithm returns to the top of the monitoring loop at step 100. If the first storage controller 20 detects that the second storage node operates abnormally, the algorithm proceeds to step 106. At step 106, the algorithm activates the first controller failover 76, which removes control of the primary storage devices of the second storage node. At step 110, the first storage controller 20 takes control of the failed second storage node's storage devices k and 2k-1 by activating the first controller path 80.

For example, at step 100, the algorithm can check the operation of the first storage node by employing a conventional watch dog timer (not shown). The processor sends a signal to the watch dog timer at intervals. As long as the signal arrives before the watch dog timer runs out of time, the timer restarts. However, if the processor fails to send a refresh signal, the timer runs out and sends an output signal generating a hard reset of the first storage node. If the first storage node operates normally, the algorithm proceeds to step 104, where the algorithm tests the operation of the second storage node. For example, the algorithm running in the first storage node can test for the normal operation of the second storage node by passing a token or a set of values indicating the status of operation of the second storage node on a heartbeat path 74 (FIG. 1) at predetermined intervals between the first and second storage controllers 20 and 40 (FIG. 1) and increment or measure the set of values the token each time it is passed. If the token is not returned with the expected value, that is, as defined by the increment, or not returned at all, the first storage node will detect that the second storage node has a software or hardware failure and go to step 106 as described earlier. At step 110, the data storage subsystem will change the path control 64 (FIG. 9) to allow the first storage node access to the storage devices normally controlled by the second storage node.

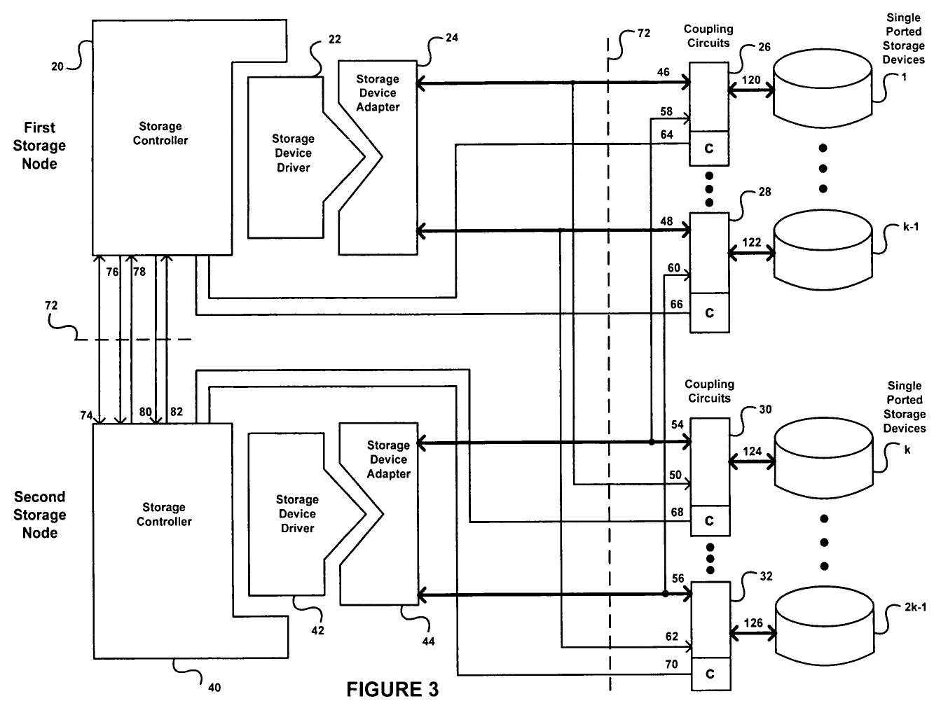

FIG. 3 shows a data storage subsystem under normal conditions where all storage nodes are operating properly. The heartbeat path 74 indicates that the storage nodes are operating normal, and the path control lines 64, 66, 68, and 70 set the coupling circuits 26, 28, 30, and 32 so data transmits on the communication paths 46 and 120, the communication paths 48 and 122, the communication paths 54 and 124, and the communication paths 56 and 126 to storage devices 1, k-1, k, and 2k-1.

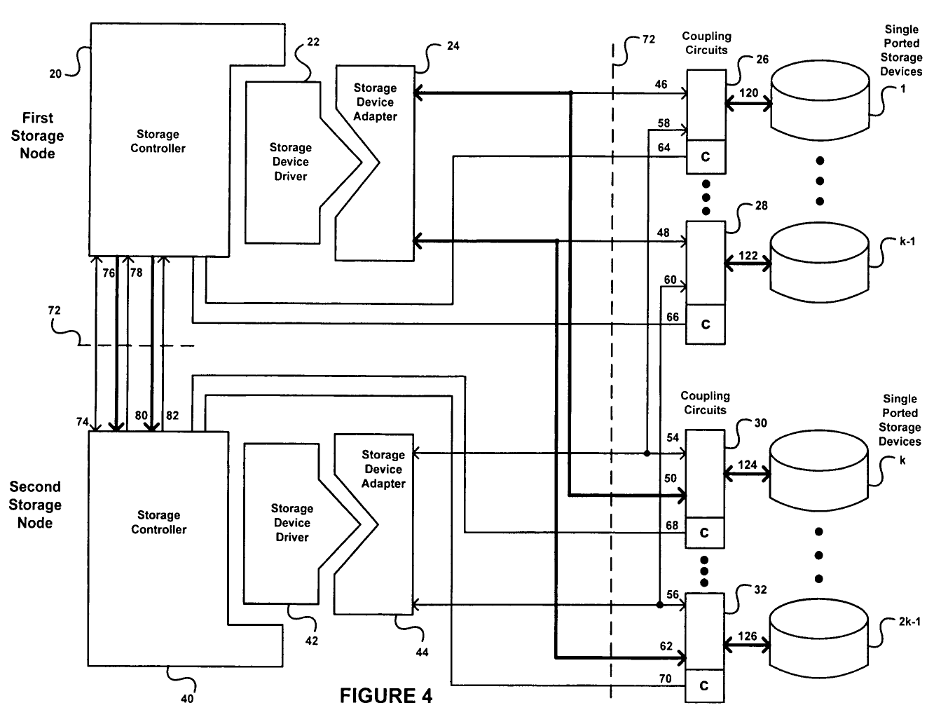

FIG. 4 shows a data storage subsystem under an abnormal condition where the second storage node has failed as indicated by shading. The heartbeat path 74 transmits either no signal or a fault signal to the first storage node indicating the second storage node has failed. The first controller failover 76 is activated disabling the failed second storage node excluding the storage devices k and 2k-1. The path control lines 64, 66, 68, and 70 set the coupling circuits 26, 28, 30, and 32 so data transmits on the communication paths 50 and 124 and the communication paths 62 and 126 to the storage devices k and 2k-1.

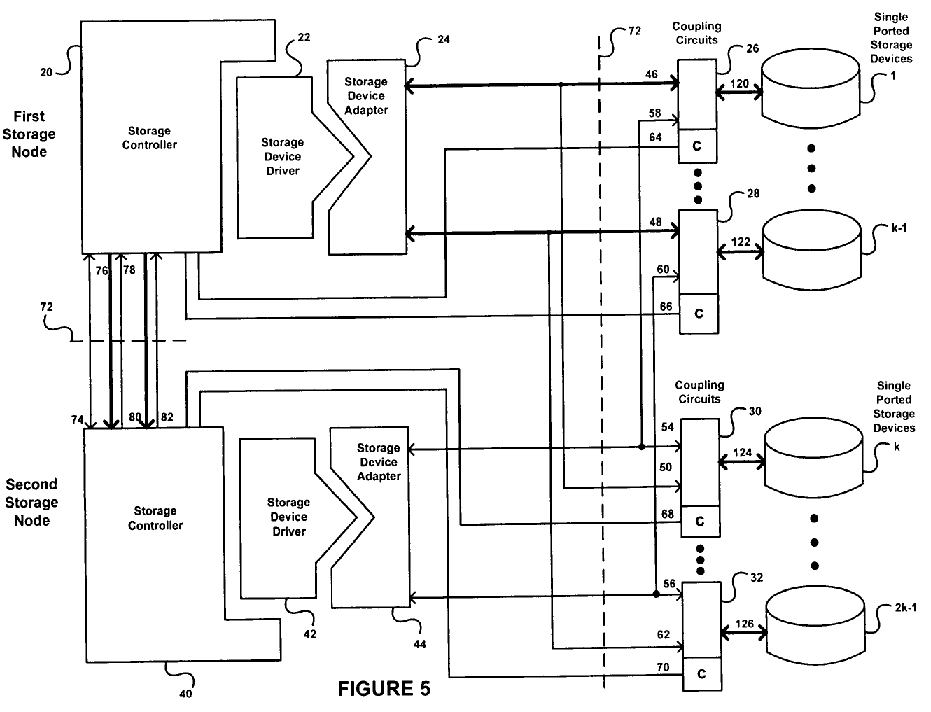

FIG. 5 shows a data storage subsystem under an abnormal condition where the second storage node has failed as indicated by shading. The heartbeat path 74 transmits either no signal or a fault signal to the first storage node indicating the second storage node has failed. The first controller failover 76 is activated disabling the failed second storage node. The path control lines 64, 66, 68, and 70 set the coupling circuits 26, 28, 30, and 32 so data transmits on the communication paths 46 and 120, and the communication paths 48 and 122 to the storage devices 1 and k-1.

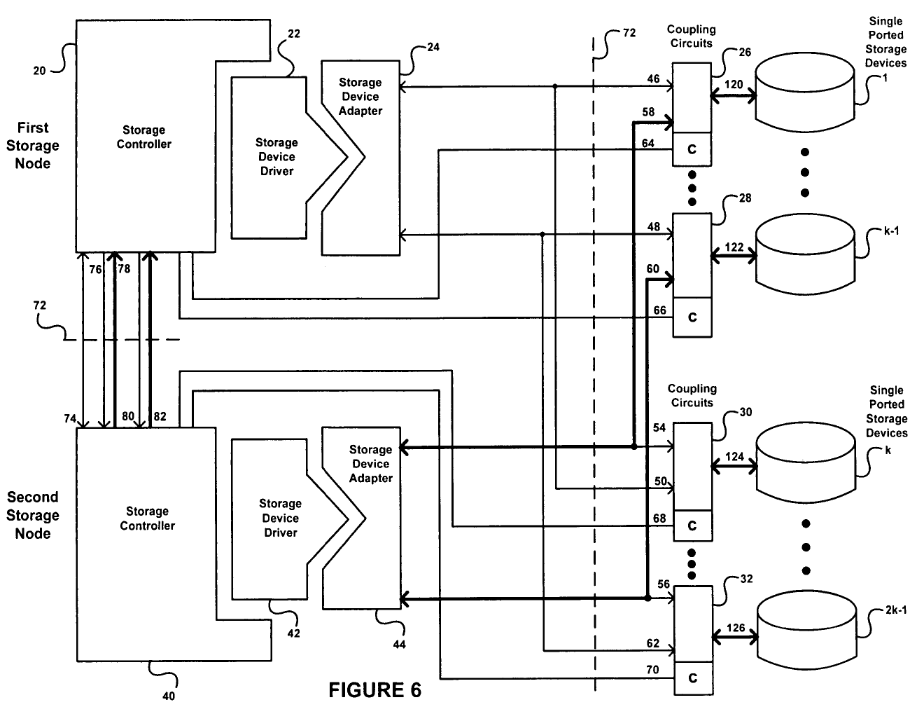

FIG. 6 shows a data storage subsystem under an abnormal condition where the first storage node has failed as indicated by shading. The heartbeat path 74 transmits either no signal or a fault signal to the second storage node indicating the first storage node has failed. The second controller failover line 78 is activated disabling the failed first storage node excluding the storage devices 1 and k-1. The path control lines 64, 66, 68, and 70 set the coupling circuits 26, 28, 30, and 32 so data transmits on the communication paths 58 and 120 and the communication paths 60 and 122 to the storage devices 1 and k-1.

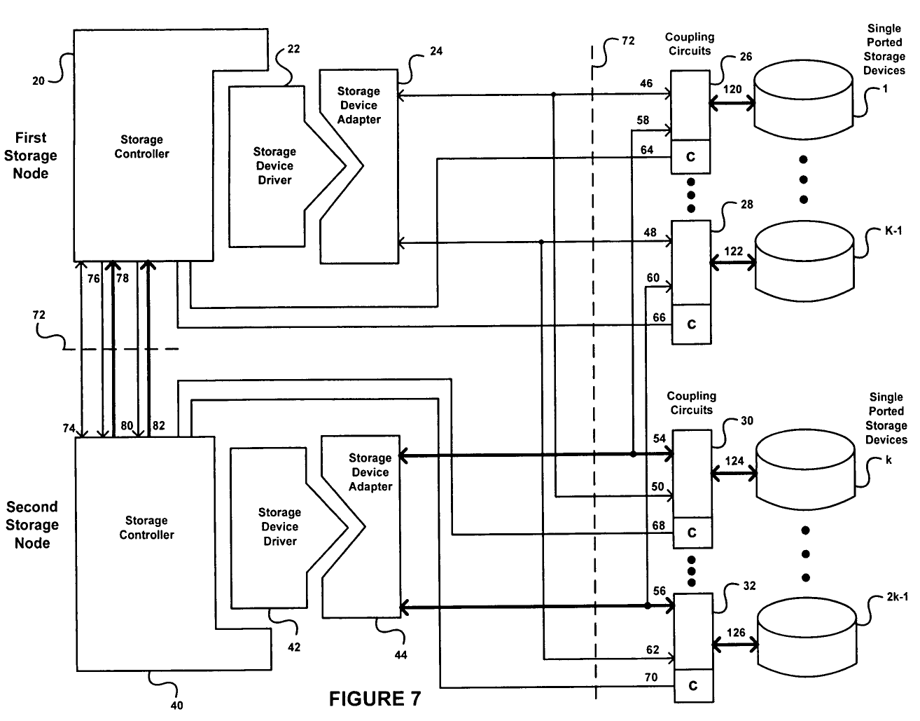

FIG. 7 shows a data storage subsystem under the same abnormal condition where the first storage node has failed as indicated by shading. The heartbeat path 74 transmits either no signal or a fault signal to the second storage node indicating the first storage node has failed. The second controller failover line 78 is activated disabling the failed first storage node. The path control lines 64, 66, 68, and 70 set the coupling circuits 26, 28, 30, and 32 so data passes along the communication paths 54 and 124, and the communication paths 56 and 126 to the storage devices k and 2k-1.

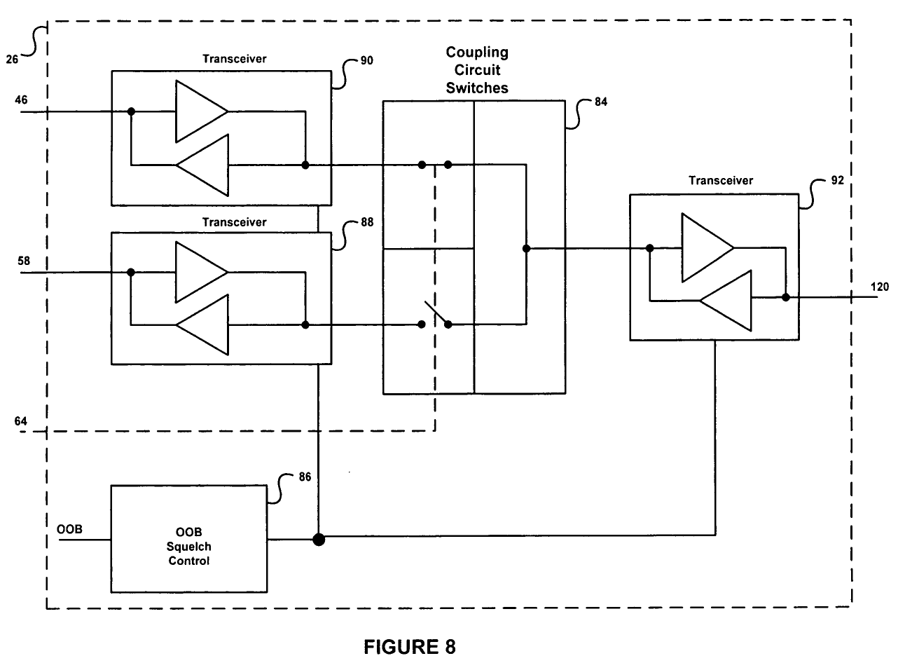

FIG. 8 is a block diagram of details of the coupling circuit 26 representative of the other coupling circuits 28, 30, and 32. Storage controller side transceivers 88, 90 and storage device side transceiver 92 provide bidirectional communication paths for passage of commands, status, and data to and from the storage devices 1, k-1, k and 2k-1. The transceivers 88, 90, 92 and the out of band (OOB) squelch control circuitry 86 are compatible with transmission specifications between the storage device adapters 24 and 44 (FIG. 1) and the storage devices 1, k-1, k, and 2k-1. A suitable specification for OOB squelch control is described at pages 85-96 in the Serial ATA Specification version 1.0, which is hereby incorporated by reference. In the path of the transceivers 88, 90, 92 is coupling circuit switches 84 and a path control line 64. The logical state of path control line 64 determines whether the communication path 46 or the communication path 58 is coupled to the communication path 120.

FIG. 9 depicts an embodiment of path control circuitry used to maintain access to the storage devices under normal or failure conditions. Each storage controller 20, 40 includes path control circuitry to drive each of the coupling circuits 26, 28, 30, and 32 (FIG. 1). The first controller path 80, the second controller failover 78, the second controller path 82, and the first controller failover 76 are input signals to the path control circuitry, whose logic states determine which of the communication paths 46 or 58, 48 or 60, 54 or 50, and 56 or 62 will appear at the communication paths 120, 122, 124, and 126, respectively, of the coupling circuits as shown in FIG. 1. The common midplane 72 provides an interconnect path for these input signals 76, 78, 80, and 82 between the first and second storage controllers 20, 40.

In normal operation, the first storage node will access its primary storage devices 1 and k-1. Thus, with regard to the storage device 1, the first storage controller 20 will set the input signals 76, 80 and the second storage controller 40 will set the input signals 78, 82 to logic states that pass the communication path 46 through the coupling circuit 26 to the communication path 120 thereby granting the first storage controller 20 access to storage device 1. Thus, with regard to the storage device k-1, the first storage controller 20 will set the input signals 76, 80 and the second storage controller 40 will set the input signals 78, 82 to logic states that pass the communication path 48 through the coupling circuit 28 to the communication path 122 thereby granting the first storage controller 20 access to storage device k-1.

Further, the second storage node will access its primary storage devices k and 2k-1. Thus, with regard to the storage device k, the second storage controller 40 will set the input signals 78, 82 and the first storage controller 20 will set the input signals 76, 80 to logic states that pass the communication path 54 through the coupling circuit 30 to the communication path 124 thereby granting the second storage controller 40 access to the storage device k. With regard to the storage device 2k-1, the second storage controller 40 will set the input signals 78, 82 and the first storage controller 20 will set the input signals 76, 80 to logic states that pass the communication path 56 through the coupling circuit 32 to the communication path 126 thereby granting second storage controller 40 access to the storage device 2k-1.

In abnormal operation, control of the access paths of the storage devices is implemented in the following manner.

If the failure is in the first storage node, excluding the storage devices, the second storage controller 40 will control the logic state of the second controller failover 78 to disable the first storage controller 20. The second storage controller 40 controls the logic state of the second controller path 82 to access the failed first storage node's storage devices 1 and k-1 or access its primary storage devices k and 2k-1.

With regard to the storage device 1, the second storage controller 40 will set the logic state of the second controller path 82 to pass the communication path 58 through the coupling circuit 26 to the communication path 120 thereby granting the second storage controller 40 access to the storage device 1.

With regard to the storage device k-1, the second storage controller 40 will set the logic state of the second controller path 82 to pass the communication path 60 through the coupling circuit 28 to the communication path 122 thereby granting the second storage controller 40 access to the storage device k-1.

With regard to the storage device k, the second storage controller 40 will set the logic state of the second controller path 82 to pass the communication path 54 through the coupling circuit 30 to the communication path 124 thereby granting the second storage controller 40 access to the storage device k.

With regard to the storage device 2k-1, the second storage controller 40 will set the logic state of the second controller path 82 to pass the communication path 56 through the coupling circuit 32 to the communication path 126 thereby granting the second storage controller 40 access to the storage device 2k-1.

If the failure is in the second storage node, excluding the storage devices, the first storage controller 20 will control the logic state of the first controller failover 76 to disable the second storage controller 40. The first storage controller 20 controls the state of the logic state of the first controller path 80 to access the failed second storage node's storage devices k and 2k-1 or access its primary storage devices 1 and k-1.

With regard to the storage device 2k-1, the first storage controller 20 will set the logic state of the first controller path 80 to pass the communication path 62 through the coupling circuit 32 to the communication path 126 thereby granting the first storage controller 20 access to the storage device 2k-1.

With regard to the storage device k, the first storage controller 20 will set the logic state of the first controller path 80 to pass the communication path 50 through the coupling circuit 30 to the communication path 124 thereby granting the first storage controller 20 access to the storage device k.

With regard to the storage device k-1, the first storage controller 20 will set the logic state of the first controller path 80 to pass the communication path 48 through the coupling circuit 28 to the communication path 122 thereby granting the first storage controller 20 access to the storage device k-1.

With regard to the storage device 1, the first storage controller 20 will set the logic state of the first controller path 80 to pass the communication path 46 through the coupling circuit 26 to the communication path 120 thereby granting the first storage controller 20 access to the storage device 1.

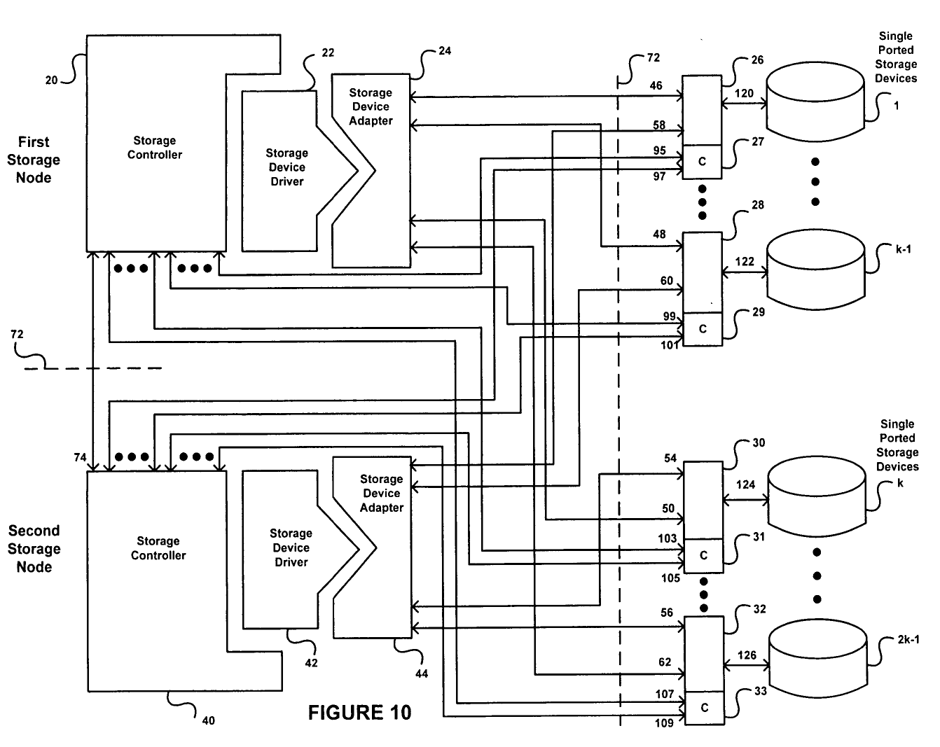

FIG. 10 illustrates a data storage subsystem as described in FIG. 1 that has bidirectional serial communication lines between each storage controller and all coupling circuits. In this subsystem, each storage controller can switch the data path of any coupling circuit, power up and down any storage device, and read the status of any coupling circuit.

This means that if the storage controller fails it will only have to be switched once and if switching causes the storage device to stop responding the storage controller can power cycle (i.e., power down and up) the storage device to restore its normal operation and thereby increase the reliability of the storage device.

If the first or second storage controller detects that the storage device has failed to respond to an I/O command in a predetermined time, the storage controller will command the coupling circuit of the storage device to power down and power up to recover normal operation of the storage device.

As shown in FIG. 10, the bidirectional serial communication lines 95, 99, 103, and 107 connect the first storage controller to the coupling circuits 26, 28, 30 and 32. Bidirectional serial communication lines 97, 101, 105, and 109 connect the second storage controller to the coupling circuits 26, 28, 30, and 32. Each coupling circuit 26, 28, 30, and 32 contains a microcontroller 27, 29, 31, and 33 to process communication between the storage controllers and the storage devices.

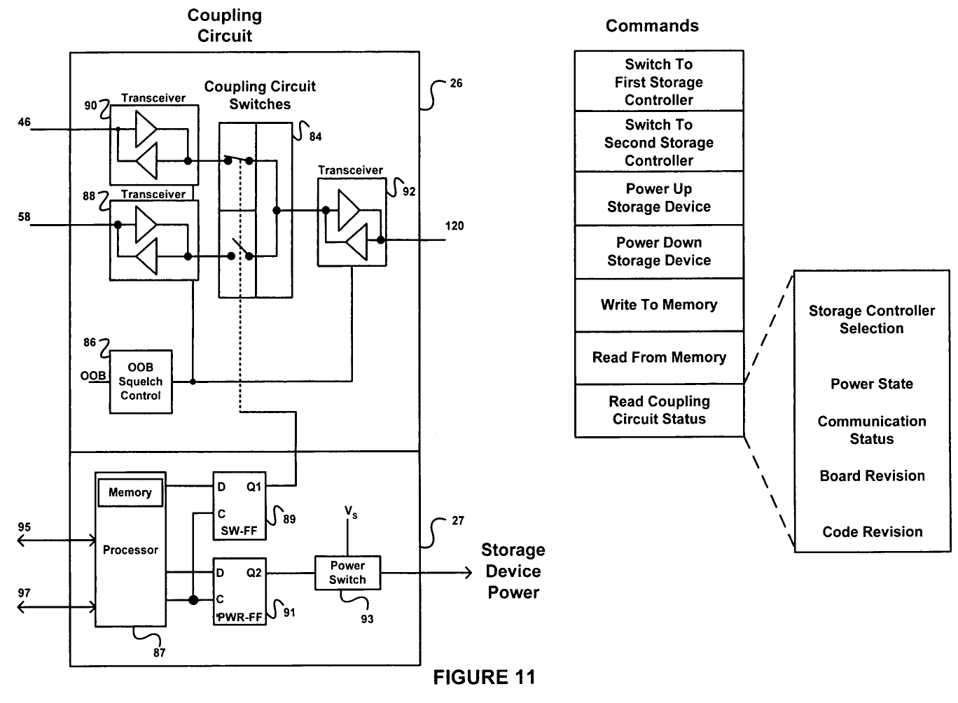

FIG. 11 illustrates an embodiment that adds intelligence and functions to the coupling circuit 26 described in FIG. 8. This embodiment has a microcontroller 27 including a processor 87 such as an ATMEL AVR RISC processor, a memory such as an EEPROM, and D flip-flops 89, 91. The D flip-flop 89 connects to the coupling circuit switch 84, and the D flip-flop 91 connects to the power switch 93 which in turn connects to the storage device power. The inputs to the processor 87 are the serial communications lines 95 and 97 that can be programmed according to the software protocols and techniques described in Application Note 126, 1-Wire Communication Through Software, and Application Note 159, Ultra-Reliable 1-Wire Communications published by Dallas Semiconductor, and hereby incorporated by reference.

FIG. 11 depicts that microcontroller 27 is adapted to perform the following illustrative commands:
1) Switch the coupling circuit 26 to first storage controller 20 (FIG. 10);
2) Switch the coupling circuit 26 to second storage controller 40;
3) Power up the storage device 1 (FIG. 10);
4) Power down the storage device 1;
5) Write data to the memory of processor 87;
6) Read data from the memory of processor 87; and
7) Read the status of the coupling circuit 26 including whether the storage device 1 is connected to storage controller 20 or storage controller 40, whether the storage device 1 is powered up or down, the communication status, and the board revision and code revision levels of the coupling circuit 26.

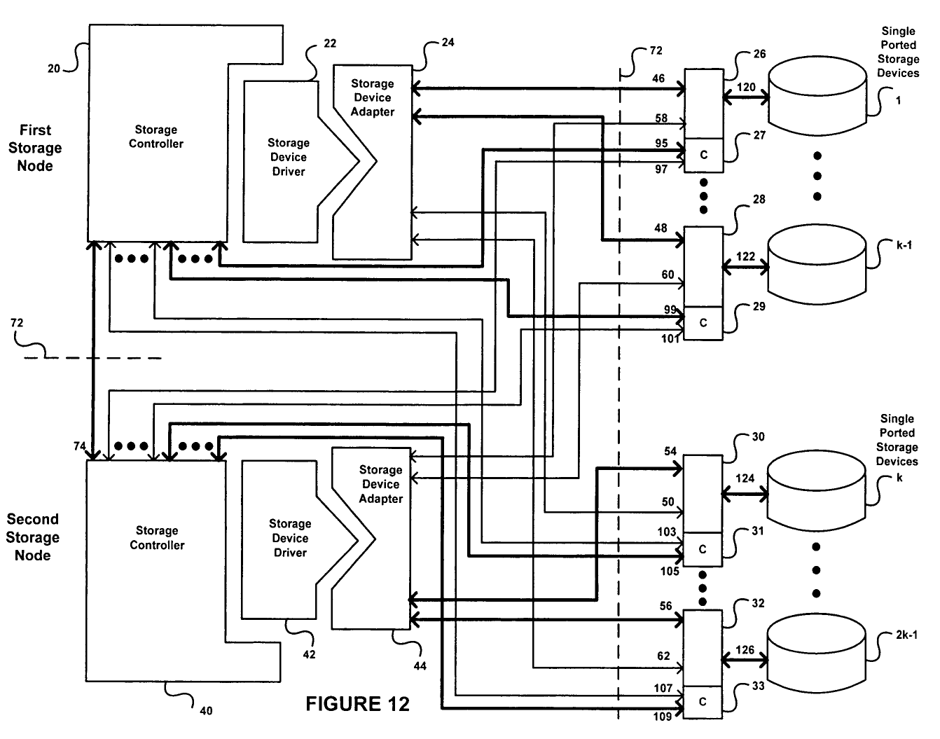

FIG. 12 illustrates the data storage subsystem using serial communication paths between the storage controllers and the storage devices during normal operation. During normal operations, the commands on the serial communication paths 95 and 99 cause the coupling circuits 26 and 28 to switch to the data paths 46 and 48 of the first storage controller 20. Commands on the serial communication paths 105 and 109 cause coupling circuits 30 and 32 to switch to the data paths 54 and 56 of second storage controller 40. Thus, the first storage node controls storage devices 1 through k-1 and the second storage node controls storage devices k through 2k-1.

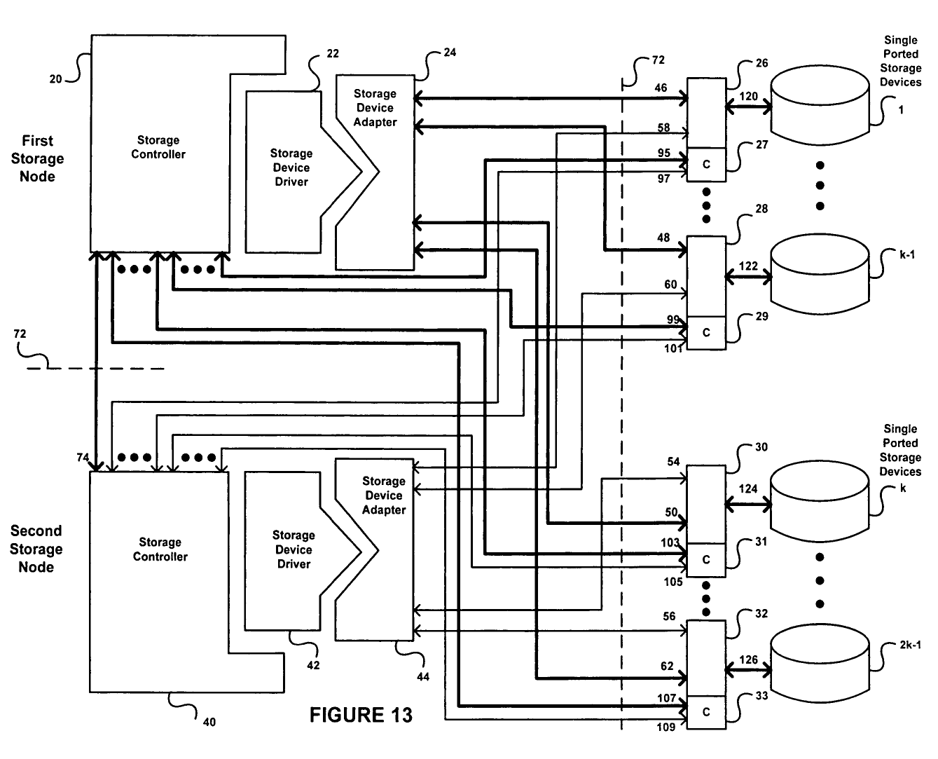

FIG. 13 illustrates the data storage subsystem using serial communication paths between the storage controllers and the storage devices when the second storage node has failed (indicated by shading). The first storage controller detects failure of the second storage controller using the heartbeat path 74 and sends commands on the bidirectional serial communication lines 103 and 107 causing the coupling circuits 30 and 32 to switch to the data paths 50 and 62 of the first storage node.

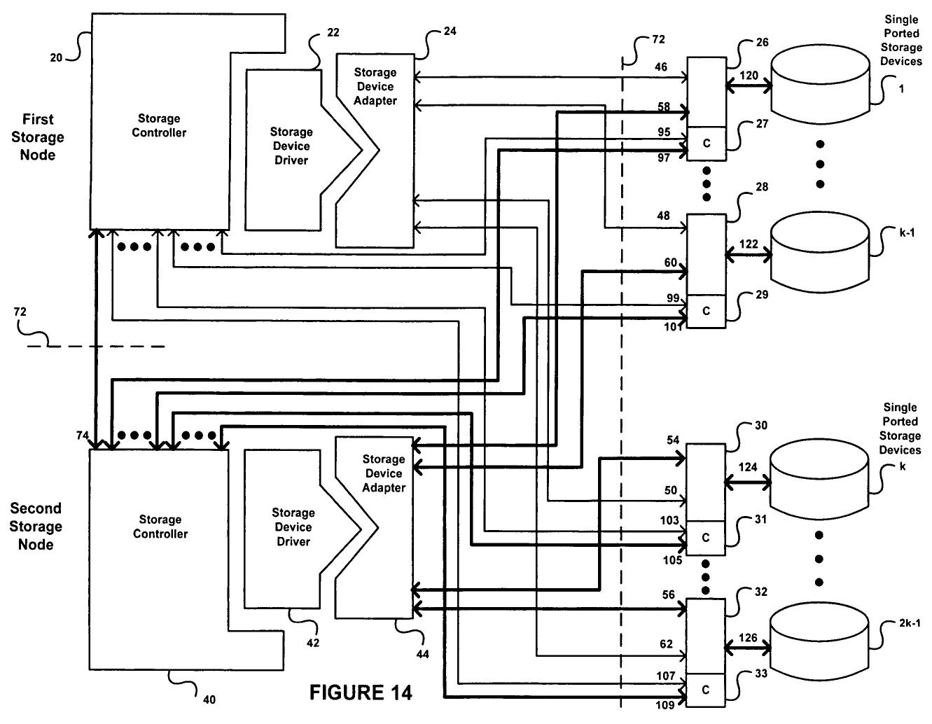

FIG. 14 illustrates the data storage subsystem using serial communication paths between the storage controllers and the storage devices when the first storage node has failed (indicated by shading). The second storage controller detects the failure of the first storage controller using the heartbeat path 74 and sends commands on the bidirectional serial communication lines 97 and 101 causing the coupling circuits 26 and 28 to switch to the data paths 58 and 60 of the second storage node.

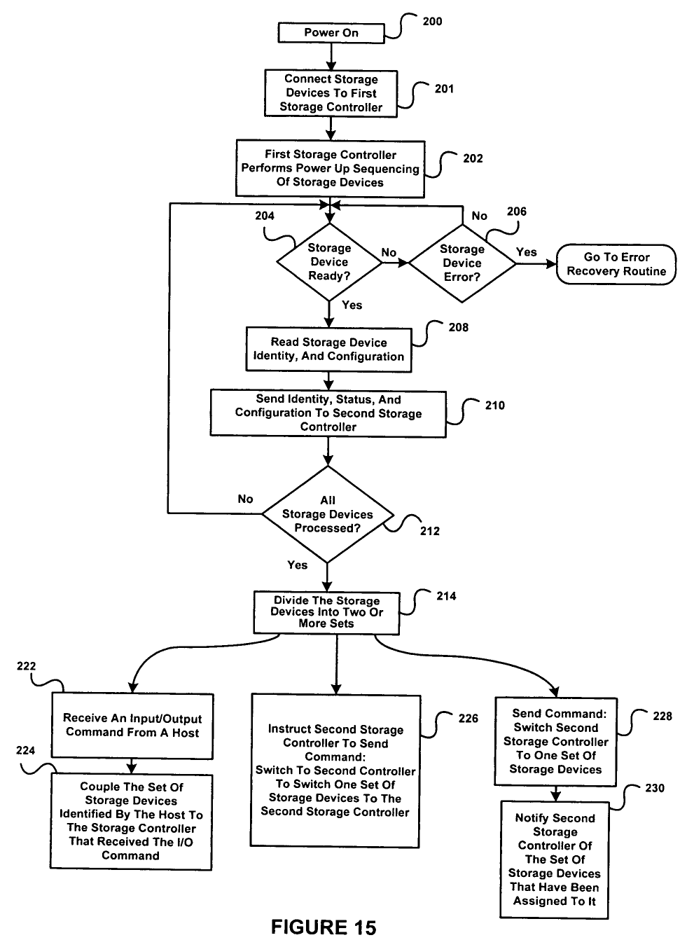

FIG. 15 illustrates a method of assigning storage devices such as Serial ATA storage devices to storage controllers where the first storage controller makes the assignments. At step 200, the method begins when system power is turned on and delivered to the first and second storage nodes except for the storage devices. At step 201, the first storage controller connects the storage devices to itself to prepare the devices to be read. The first storage controller then commands the coupling circuits to power up the corresponding storage devices. The first storage controller powers up the storage devices in a known staggered sequence (e.g., one per five seconds) at step 202 to lower the peak power requirement. At step 204, the first storage controller checks each storage device to determine if it is ready for use. If not ready within a fixed time, there may be a storage device error so the first storage controller tests for storage device error at step 206, and if error is found, the first storage controller goes to a known error recovery routine. Once a storage device is ready, the first storage controller reads its identity (e.g., disk drive identity) at step 208. The first storage controller optionally reads the storage device status (e.g., media condition) and configuration (e.g., manufacturer and capacity of a disk drive) at step 208. At step 210, the first storage controller sends the information read at step 208 to the second storage controller. At step 212, the first storage controller tests if all of the storage devices have been processed through steps 204 through 210, and if not, the first storage controller returns to step 204 to process the rest of the storage devices. At step 214, the first storage controller divides the storage devices into one or more sets. In an embodiment, the first storage controller divides thirteen storage devices into two sets of six storage devices plus a spare. In another embodiment, the first storage controller handles all the storage devices as one set and a second storage controller handles the set if the first storage controller fails.

When all of the storage devices have been processed through steps 204 to 210, the data storage subsystem assigns each set of storage devices to the first storage controller or the second storage controller and couples each set of storage devices to the first storage controller or the second storage controller by issuing commands to the coupling circuits. The assignment and coupling can be performed:

1) The first storage controller or second storage controller receives a host I/O command at step 222 and couples (i.e., commands the coupling circuit to connect) to the storage devices identified in the I/O command at step 224;

2) The first storage controller assigns the set(s) to the second storage controller and instructs the second storage controller to couple to the set(s) of storage devices at step 226; or

3) The first storage controller assigns the set(s) to the second storage controller, couples the set(s) to the second storage controller at step 228 and notifies the second storage controller of the assignment at step 230.

1-20. (canceled)

21. A method of restoring operation of a Serial ATA storage device, comprising:
detecting the Serial ATA storage device has failed to respond to an I/O command within a predetermined time;
commanding a coupling circuit to power down the Serial ATA storage device for a predetermined time; and
commanding a coupling circuit to power up the Serial ATA storage device.

22-23. (canceled)
